(19) United States
(12) Patent Application Publication
(10) Pub. No.: US 2008/0047671 A1
(43) Pub. Date: Feb. 28, 2008

(54) Process for the Recovery of a Polymer in Solution

(75) Inventor: Bernard Vandenhende, Leest (BE)

Correspondence Address: OBLON, SPIVAK, MCCLELLAND MAIER & NEUSTADT, P.C., 1940 DUKE STREET, ALEXANDRIA, VA, 22314, US

(73) Assignee: Solvay (Societe Anonyme), Brussels (BE)

(21) Appl. No.: 11/578,347

(22) PCT Filed: Apr. 7, 2005
(86) PCT No.: PCT/EP05/51555

§ 371 Date: Oct. 12, 2006

(30) Foreign Application Priority Data
Apr. 13, 2004 (FR) 04 03856

(51) Int. Cl. C08F 6/12

(52) U.S. Cl. 159/47.1

(57) ABSTRACT

Process for the recovery of a polymer in solution Process for the recovery of a polymer in solution in a solvent, the combined material forming a homogeneous medium, according to which: a) a nonsolvent is added to the homogeneous medium so as to render it heterogeneous; b) the heterogeneous medium is subjected to shearing and to a supply of thermal energy sufficient to evaporate the solvent and nonsolvent and to provide polymer particles; c) the polymer particles are recovered.

The present invention relates to a process for the recovery of a polymer in solution.

Polymers are widely used in various forms, mainly in the solid state. However, it often happens that, at a given moment in their existence, they are in solution in a solvent from which it is then necessary to extract them. Thus, polymer solutions are encountered at the end of some polymerization processes (“solution” polymerization processes), during some recycling processes, during the cleaning of some plants for the manufacture of objects or of paints based on polymers, and the like. The recovery of the polymer in the solid state starting from a solution generally involves at least one stage of evaporation of the solvent. In point of fact, this operation is often expensive due to its energy consumption and it does not necessarily result in polymer particles with an appropriate particle size. In addition, these polymers particles often have a not insignificant residual solvent content (typically of greater than 500 ppm).

To overcome these disadvantages, the Applicant Company has developed an improved process, forming the subject-matter of several patent applications, including in particular Applications FR 2 776 663, WO 01/23463, WO 01/70865, WO 03/054064, FR 03.08690 and FR 03.08691, the key to which consists in precipitating the polymer in solution by addition of a nonsolvent and in subsequently removing the solvent and the nonsolvent, either by atomization (as in Application WO 03/054064) or by azeotropic distillation (as in the other patent applications mentioned).

Numerous other processes/devices for the removal of the solvent and of the nonsolvent exist: film evaporator, wiped film evaporator, flash devolatilization, and the like. These processes consist of a bulk removal of the solvent, they are limited by the viscosity of the polymer and are therefore generally followed by a stage of finishing in an extruder with a degassing vent, drawing under vacuum, with or without a stripping agent. Furthermore, these processes are limited by the behaviour of the polymer and more particularly are not well suited to heat-sensitive polymers, such as PVC, PVDC, PVDF, and the like.

One known solution for overcoming these disadvantages consists in devolatilizing the solution under high shear and while supplying thermal energy. However, during such a process, generally, the viscosity of the product increases very strongly to reach a maximum value and to subsequently plummet, this point being characterized by the loss of elasticity of the polymer and its fragmentation into particles with a size of several mm. In point of fact, the thermal energy transmitted is that from a wall towards a powder with a coarse and therefore unfavourable particle size. Moreover, once this stage has been passed, a phenomenon of diffusion of the solvent through the grain occurs, which means that, even after a lengthy period of treatment, the solvent contents are high (of the order of a %).

The present invention is based on the surprising observation that, provided that the homogeneous solution of polymer is rendered heterogeneous before the devolatilization (by shearing/thermal energy), the disadvantages mentioned above can be avoided and a powder (polymer particles) is obtained with a good particle size and with a low residual solvent content. In addition, in comparison with the prior process developed by the Applicant Company, the process which is a subject-matter of the present application makes it possible to drastically reduce the amounts of energy consumed, since there is less nonsolvent to be treated and to be heated. Moreover, the absence of generation of aqueous mother liquor results in markedly lower volumes of effluents to be treated.

The present invention consequently relates to a process for the recovery of a polymer in solution in a solvent, the combined material forming a homogeneous medium, according to which:
a) a nonsolvent is added to the homogeneous medium so as to render it heterogeneous;
b) the heterogeneous medium is subjected to shearing and to a supply of thermal energy sufficient to evaporate the solvent and nonsolvent and to provide polymer particles;
c) the polymer particles are recovered.

The polymer, the recovery of which is targeted by the process according to the present invention, can have any nature. It can be a thermoplastic resin or an elastomer but, in any case, a resin which can be dissolved in a solvent and which therefore is not or only slightly crosslinked. It can be an unused (or virgin) resin which has not been subjected to any melt forming, except possible granulation, or a used resin (production waste or recycled resin). It can be a nonpolar polymer, such as a polymer of ethylene (PE) or of propylene (PP). It can also be a polar polymer, such as a polymer of vinyl chloride (PVC), of vinylidene chloride (PVDC), of vinylidene fluoride (PVDF) or of EVOH (copolymer of ethylene and of vinyl alcohol). It can also be a conventional polymer, such as PS (polystyrene), ABS (acrylonitrile/butadiene/styrene copolymer), PC (polycarbonate) or SAN (styrene/acrylonitrile copolymer). It can also be a blend of at least two such polymers, of the same nature or with different natures. Good results have been obtained with PVC (homo- or copolymer comprising at least 50% by weight of vinyl chloride), PS, ABS, PC, PVDF (both vinylidene fluoride homopolymers and vinylidene fluoride copolymers comprising less than 50% by weight of monomer units such as vinyl fluoride, trifluoroethylene, chlorotrifluoroethylene, tetrafluoroethylene, hexafluoropropylene, ethylene, and the like) and PVDC.

The process according to the present invention applies to polymers substantially in solution in a solvent, that is say forming a homogeneous liquid phase with it. Thus, if it is desired to apply it to the recovery of solid articles or of suspensions formed of polymer (for example in heavy liquids), it is advisable first to dissolve these articles or particles in suspension using a solvent, the nature of which is suited to that of the polymer to be dissolved and which forms a homogeneous medium with the possible heavy liquids.

The solvent in which the polymer is dissolved is generally a liquid having a solubility parameter (a definition and experimental values of which appear in “Properties of Polymers”, D. W. Van Krevelen, 1990 edition, pp. 200-202, and in “Polymer Handbook”, J. Brandrup and E. H. Immergut, Editors, Second Edition, p. IV-337 to IV-359) in the region of the solubility parameter of the polymer. It is understood that the term “solvent” means both a pure substance and a mixture of substances. In the case where the polymer is PVC or PVDF, a solvent which is highly suitable is MEK (methyl ethyl ketone). In the case where the polymer is EVOH, a mixture of water and of alcohol (ethanol, methanol, propanol, and the like) is most suitable and, in the case of LDPE, hexane or cyclohexane are preferred. In the case where the polymer is PVDF or PVDC, cyclohexanone is highly suitable. Other solvents (preferably polar solvents) can also be used: DEK (diethyl ketone), MIBK (methyl isobutyl ketone), THF (tetrahydrofuran), cyclohexanone, cyclopentanone, and the like.

The solutions which can be treated by the process according to the present invention have a concentration of polymer such that their viscosity does not interfere with the satisfactory progression of the process. The concentration can nevertheless be very high with some devices available on the market (for example with the Discotherm B Processor from List). Thus, good results have been obtained with a polymer content of more than 250 g per kg of solvent and even more than 650 g/kg in the case of PVC.

In the process according to the invention, it is advantageous for the solvent used to be miscible with the nonsolvent and to form an azeotrope with it. This is because this often makes it possible to evaporate the two compounds with a reduced energy consumption. In particular, when the polymer is PVC, the solvent is advantageously methyl ethyl ketone (MEK) and the nonsolvent is water as these compounds form a azeotrope comprising (at atmospheric pressure) 11% of water and 89% of MEK (by weight).

The amount of nonsolvent to be added according to the invention has to be sufficient to render the medium (polymer solution) heterogeneous. It therefore depends on the nature of the polymer, of the solvent and of the nonsolvent and on the temperature and pressure conditions. Preferably, the amount and the conditions for addition of the nonsolvent are such that the latter is dispersed virtually exclusively in the organic phase (polymer solution) without being mixed with the latter. To this end, the polymer solution preferably comprises a phase-separation agent, defined as being a compound having a high affinity for the solvent and being miscible with it and, in contrast, being incompatible and immiscible with the nonsolvent. Such a compound effectively makes it possible to promote the dispersion of the nonsolvent in the polymer solution without the nonsolvent entering (being mixed with) the polymer solution. It promotes the preparation of an emulsion or of a dispersion of the nonsolvent in a continuous liquid medium composed of the solvent, of the phase-separation agent, of the substantially dissolved polymer and of the possible additives present in the polymer before its dissolution. In the case where the solvent is MEK and the nonsolvent is water, hexane gives good results as phase-separation agent.

In the process according to the present invention, it is generally advantageous to collect and to condense the vapours generated during stage (b), this being not only for obvious environmental reasons but also for the purpose optionally of being able to reuse the compounds from these vapours in a subsequent process. The process according to the invention thus makes it possible to operate in a closed loop (either continuously or batchwise) without generating discharges.

In the process according to the invention, it may prove to be advantageous for the nonsolvent added in stage (a) optionally to comprise a low concentration of solvent; this is advantageous insofar as, as set out above, the process would use a stream recovered from a prior similar process. For the same reason, it may also prove to be advantageous for the solvent to comprise a certain amount of nonsolvent.

In some cases, the homogeneous liquid medium subjected to stage (a) or even the heterogeneous medium obtained on conclusion of stage (a) can be purified from one or more of its constituents before applying to it the continuation of the process according to the invention. Thus, for example, the component or components with a low boiling point can be removed by simple evaporation (stripping).

In an advantageous alternative form of the process according to the invention, the dissolution of the polymer and stage (a) are carried out at a higher temperature and a greater pressure than ambient temperature and atmospheric pressure and the heterogeneous medium obtained on conclusion of stage (a) is subjected to a reduction in pressure before stage (b). To proceed in this way makes it possible to already remove a significant portion of the solvent and of the phase-separation agent, if appropriate.

It should be noted that, as briefly mentioned above, the heterogeneous medium can comprise additives initially present in the polymer solution (for example pigments, plasticizers, stabilizers, fillers, and the like, present in the polymer before its dissolution) or intentionally added to the homogeneous polymer solution or to the heterogeneous medium.

The devolatilization (stage (b)) included in the process according to the present invention is carried out using any known device capable of supplying the necessary mechanical energy (shearing) and thermal energy. Good results have been obtained with a device comprising a cylindrical horizontal reactor, the wall of which is equipped with a heated jacket (which makes it possible to introduce thermal energy) and which is equipped with a heated hollow shaft, with rotating blades and with stationary blades, without any contact between them, and with a device for collecting vapours. It is preferably a device similar to that from List mentioned above, that is to say comprising a cylindrical horizontal reactor equipped with a shaft with a slow rotational speed, which makes it possible to apply shearing to the medium, and equipped with rotating blades and with stationary blades, without any contact between the stationary blades and the moving blades. The latter advantageously rotate at a speed of less than or equal to 80 rpm (revolution/min), indeed even less than or equal to 60 rpm; however, this speed is advantageously greater than or equal to 20 rpm or even greater than or equal to 30 rpm. This device comprises a single axle and devolatilization is carried out by opening the head space of the reactor to a condenser maintained under a pressure which can be atmospheric pressure, for example, but which can also be a vacuum at a pressure of 100 mbara or more, indeed even +/−250 mbara or more. The heat to provide for this devolatilization is supplied by the wall, which is equipped with a jacket, and by the axle, which is a heated hollow shaft. To this end, the thermal fluid used in the jacket can be at a temperature of 80° C. or more, indeed even 100° C. or even 120° C. or more.

The polymer particles recovered on conclusion of stage (b) (by any known means but generally by simple collecting in a suitable container) are advantageously subjected to desorption and/or to drying before storage and/or processing.

The process according to the present invention can be incorporated in any process involving the recovery of a polymer from a solution. In particular, it can form part of a process for the recycling of polymer(s).

Thus, according to a preferred alternative form, the process according to the present invention is applied to a polymer solution obtained by shredding polymer-based articles into fragments with a mean size of 1 cm to 50 cm, in the event of these sizes being exceeded, and by bringing the fragments of articles into contact with a solvent capable of dissolving the polymer. Preferably, in this process, the polymer is PVC (optionally with the addition of plasticizer), the solvent is an MEK-hexane mixture optionally comprising water, and the nonsolvent is water.

The process according to the present invention makes it possible to obtain a very porous powder. This powder is generally formed of substantially spherical polymer particles. These particles generally have a mean diameter of less than 100 μm and preferably of less than or equal to 50 μm. However, it is rare for the mean diameter of these particles to be less than 1 μm, indeed even less than 5 μm.

Such particles can be used as is in certain applications, such as rotomoulding or slush moulding, or can be introduced as is into a plastisol intended to be coated and gelled. Alternatively, these particles can be granulated in an extruder or, more advantageously, sintered, so as to prevent thermal ageing of the polymer.

In comparison with the processes of the prior art, the process according to the invention exhibits, as advantages other than the morphology of the product obtained:
the absence of phase inversion and of concentration limit of polymer in the solvent;
the absence of aqueous mother liquors to be treated;
good desorption of the solvent due to the fine particle size of the product.

The present invention is illustrated without implied limitation by the following examples.

### EXAMPLE 1

### Not in Accordance with the Invention

A test was carried out starting from a PVC solution having a concentration of PVC of 40% by weight and of solvent of 60% by weight. The solvent used is a solvent comprising a nonsolvent residue and the phase-separation agent with the following composition: 80% of MEK, 15% of hexane, 5% of water.

The solution was introduced into the device described above and heated (to a temperature of 100° C.), and a partial vacuum (low pressure 250 mbar) was produced. The body of the material was kept homogeneous by stirring (at 60 rpm).

The solvent was gradually removed, while the jacket was maintained at a temperature of the order of +/−110° C. The viscosity of the product increased very strongly, to reach a maximum value and to subsequently plummet. This point was characterized by the loss of elasticity of the product and the splitting/fragmentation thereof into particles with a size of several mm. The drying of the product was continued but resulted in a powder with a coarse and thus unfavourable particle size and which has a high solvent content (of the order of a %).

### EXAMPLE 2

### In Accordance with the Invention

This test was carried out under conditions similar to those of Example 1 but, prior to the devolatilization, an amount of water was dispersed in the solution so as to have a concentration of water in the MEK of greater than 12%. This water was easily dispersed in the solution in the light of the presence of the phase-separation agent.

Once this mixture was introduced into the device (as described above), the jacket was heated and a partial vacuum was applied in order to carry out the devolatilization.

The solvent evaporated at the beginning was rich in phase-separation agent. The moment its concentration fell, the water (nonsolvent) was absorbed by the solvent.

The moment the solvent (MEK) comprised 10 to 12% of water, the PVC resin precipitated and the smooth slurry became a granular slurry.

When the solvent content of the product present in the device was of the order of 20 to 30% of residual solvent, the product already behaved as a free-flowing powder.

It was subsequently poured into a jacketed stirred dryer, where the drying and the evaporation of the residual water and solvent were continued (simpler stirred dryer no longer requires shearing but a simple movement of the powder).

1. A process for the recovery of a polymer in solution in a solvent, the combined material forming a homogeneous liquid medium, said process comprising the steps:
a) adding a nonsolvent to said homogeneous medium in order to render it heterogeneous;
b) subjecting said heterogeneous medium to shearing and to a supply of thermal energy sufficient to evaporate the solvent and nonsolvent and to provide polymer particles; and
c) recovering said polymer particles.

2. The process according to claim 1, in which the solvent and the nonsolvent form an azeotrope.

3. The process according to claim 1, in which the polymer solution comprises a phase-separation agent which is also evaporated in step (b).

4. The process according to claim 3, in which the heterogeneous medium is essentially composed of an emulsion or of a dispersion of the nonsolvent in a continuous liquid medium composed of the solvent, of the phase-separation agent, of the substantially dissolved polymer and of the possible additives present in the polymer before its dissolution.

5. The process according to claim 3, in which the polymer is PVC (vinyl chloride polymer), the solvent is essentially composed of MEK (methyl ethyl ketone), the phase-separation agent is hexane and the nonsolvent is essentially composed of water.

6. The process according to claim 1, in which the vapours generated during step (b) are collected and condensed.

7. The process according to claim 1, in which the polymer particles recovered are subjected to desorption and/or to drying.

8. The process according to claim 1, in which the dissolution of the polymer and step (a) are carried out at a higher temperature and a greater pressure than ambient temperature and atmospheric pressure and the heterogeneous medium obtained on conclusion of step (a) is subjected to a reduction in pressure before step (b).

9. The process according to claim 1, in which step (b) is carried out in a device comprising a cylindrical horizontal reactor, the wall of which is equipped with a heated jacket and which is equipped with a heated hollow shaft, with rotating blades and with stationary blades, without any contact between them, and with a device for collecting the vapours generated in step (b).

10. The process according to claim 1, characterized in that it is incorporated in a process for the recycling of polymer(s).
